(19) United States
(12) Patent Application Publication
(10) Pub. No.: US 2012/0158309 A1
(43) Pub. Date: Jun. 21, 2012

(54) Modeling Immiscible Two Phase Flow in a Subterranean Formation

(76) Inventor: Mohammed Jawad D. Alshakhs, Al-Hofuf City (SA)

(21) Appl. No.: 12/974,434

(22) Filed: Dec. 21, 2010

(51) Int. Cl. G06F 19/00

(52) U.S. Cl. 702/12

(57) ABSTRACT

The propagation of a flood front as it is being injected in a porous media segment such as a subterranean oil-bearing formation or a core composite is measured as a function of time during a number of discrete time steps. A model is formed of measures of water saturation profiles along the length of travel through the porous media segment for the time steps. The model in effect subdivides the porous media segment into individual sections or subsystems of equal distances. The saturation of each subsystem is determined based on the volume of the fluid injected, the pre-determined fractional flow and the initial average saturation.

### BACKGROUND OF THE INVENTION

1. Field of the Invention

The present invention relates to computerized subterranean reservoir analysis, and in particular to forming models of the flow of two immiscible fluid phases for core sample permeability testing and for reservoir simulation.

2. Description of the Related Art

It has been conventional practice at some time during the production life of a subsurface hydrocarbon reservoir or formation to increase production by recovery techniques. Among such techniques is the injection of water. Water and oil are immiscible, in that they do not mix with each other or chemically react with each other. The flow rates through the formation rock sands of the fluids present in the reservoirs (oil, gas and water) as a rule also differ for the different fluids.

During the life of the reservoir, it has been typical practice to form models or simulations of the flow of these fluids through the reservoir. This was done in order to accurately evaluate and analyze the potential or historic production from the reservoir.

In forming models or simulations of reservoir fluid flow, the behavior of the immiscible fluids had to be taken into account. A model known as the Buckley Leverett model has been widely used for a number of years. This technique was originally described in “Mechanism of Fluid Displacement in Sands”, S. E. Buckley and M. C. Leverett, Trans. AIME (1942), Vol. 145, p. 107-116. Over the ensuing years, there have been certain problems noted in the literature with this method. A specific problem is that the formation fluid saturation values produced with the Buckley Leverett method indicated multiple values of fluid saturation for the same physical location, which by definition cannot occur.

### SUMMARY OF THE INVENTION

Briefly, the present invention provides a new and improved computer implemented method of obtaining a measure of saturation of a porous media segment of earth formation rock to an injected volume of fluid. A length of a system sample of the porous media segment is partitioned into a number of sample length increments, and a measure is formed of the volume of injected fluid injected into a sample length increment during a selected increment of time. A measure is then formed of fractional flow of fluid produced in the sample length increment by the injected fluid during the selected time increment, and a measure formed of the fluid saturation for the injected fluid in the sample length increment during the selected time increment. A record is then made of the measure of the of the fluid saturation for the injected fluid in the sample length increment during the selected time increment, and a measure formed of the remaining volume of the fluid not saturated into the sample length increment during the selected time increment.

The present invention also provides a new and improved data processing system for forming a measure of saturation of a porous media segment of earth formation rock to an injected volume of fluid. The data processing system comprises a data storage memory and a processor which performs the steps of partitioning a length of a system sample of the porous media segment into a number of sample length increments, and forming a measure of the volume of injected fluid injected into a sample length increment during a selected time increment. The processor also forms a measure of fractional flow of fluid produced in the sample length increment by the injected fluid during the selected time increment and a measure of the fluid saturation for the injected fluid in the sample length increment during the selected time increment. The processor also forms a record in the data storage memory of the measure of the of the fluid saturation for the injected fluid in the sample length increment during the selected time increment, and forms a measure of the remaining volume of the fluid not saturated into the sample length increment during the selected time increment.

The present invention further provides a new and improved data storage device which has stored in a computer readable medium computer operable instructions for causing a data processing system to form a measure of saturation of a porous media segment of earth formation rock to an injected volume of fluid, the instructions stored in the data storage device causing the data processing system to partition a length of a system sample of the porous media segment into a number of sample length increments, and form a measure of the volume of injected fluid injected into a sample length increment during a selected time increment. The instructions stored in the data storage device include instructions causing the data processing system to form a measure of fractional flow of fluid produced in the sample length increment by the injected fluid during the selected time increment, and a measure of the fluid saturation for the injected fluid in the sample length increment during the selected time increment. The instructions stored in the data storage device also include instructions causing the data processing system to form a record for storage in the data processing system of the measure of the of the fluid saturation for the injected fluid in the sample length increment during the selected time increment, and further to form a measure of the remaining volume of the fluid not saturated into the sample length increment during the selected time increment.

### BRIEF DESCRIPTION OF THE DRAWINGS

FIG. 1 is a graphical display of a measure of fractional flow profile as a function of water saturation.

FIG. 2 is a graphical display of a measure of water flood saturation as a function of non-dimensional distance formed from the set of data used for the display of FIG. 1 using the prior art Buckley Leverett model without applying any correction.

FIG. 3 is graphical display of a measure of shock front water saturation profile as a function of non-dimensional distance formed from the set of data used for the display of FIG. 1 using the prior art Buckley Leverett model corrected by the utilization of average water saturation.

FIG. 4 is a schematic diagram of a computer system for modeling fluid flow for subsurface earth formations according to the present invention.

FIG. 5 is functional block diagram of a set of data processing steps performed in the computer system of FIG. 4 during the forming of fluid flow models for subsurface earth formations according to the present invention.

FIG. 6 is a graphical display of a synthetic typical example of fractional flow profile of an injected fluid as a function of water saturation.

FIG. 7 is a graphical display of a measure of water saturation profile as a function of non-dimensional distance formed from the data set used for the display of FIG. 6 according to the present invention for various pore volume (PV) ratios.

FIG. 8 is a graphical display of measures of water saturation profile as a function of non-dimensional distance formed from the data set used for the display of FIG. 6 according to the present invention before and after data smoothing techniques are applied.

FIG. 9 is a graphical display of comparison plots of measures of saturation profile formed from the data set used for the display of FIG. 6 from synthetic data and from the prior art Buckley Leverett method.

FIG. 10 is a graphical display of synthetic fractional flow profiles as a function of saturation.

FIG. 11 is a graphical display of synthetic fractional flow profiles as a function of saturation.

### DETAILED DESCRIPTION OF THE PREFERRED EMBODIMENTS

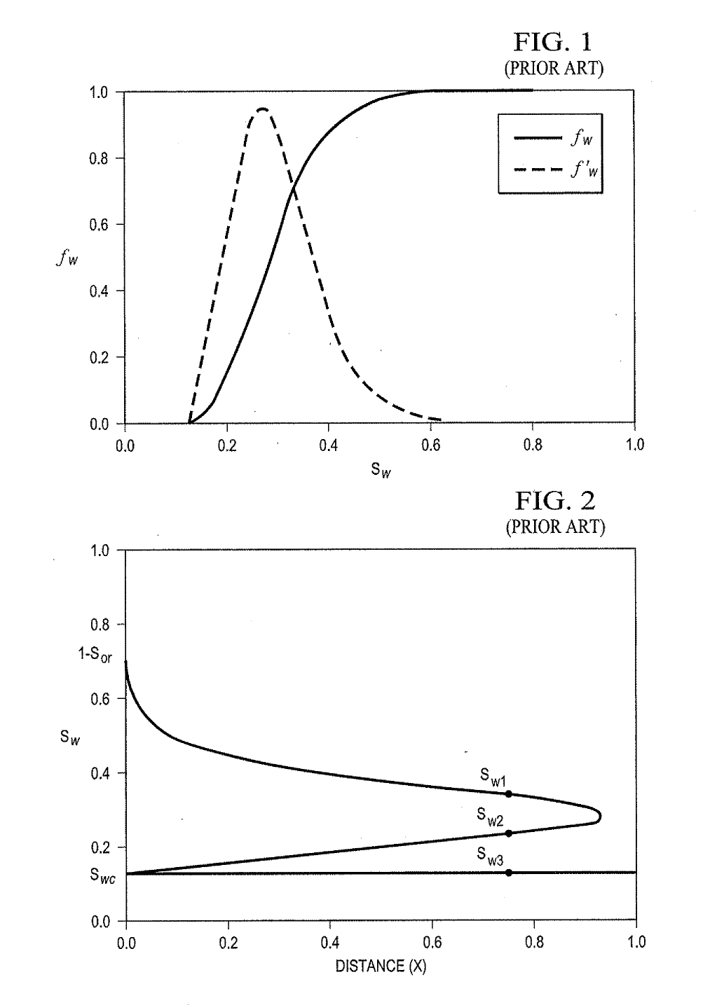

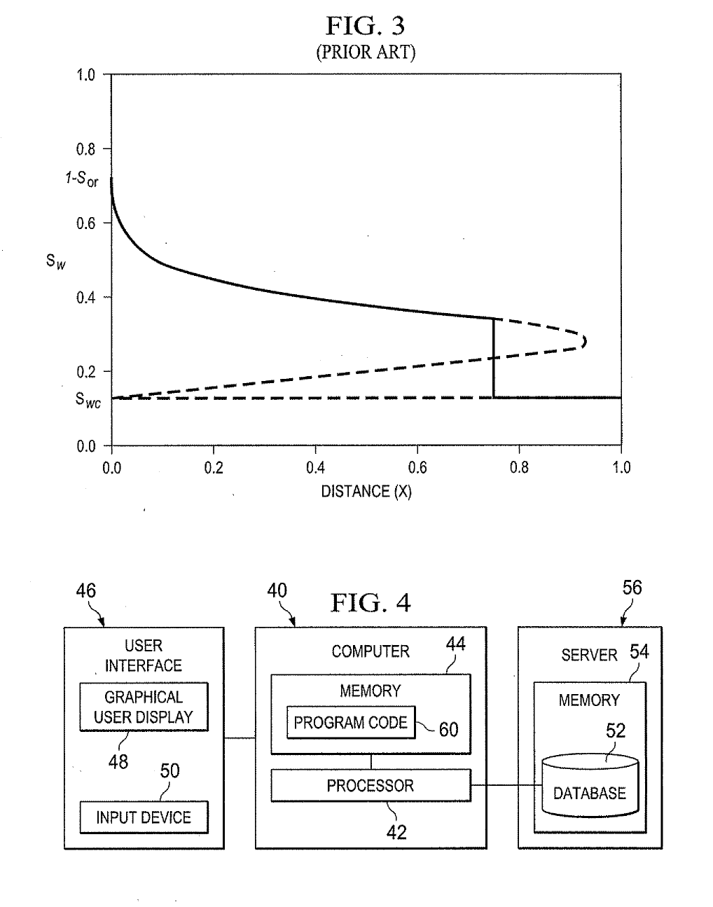

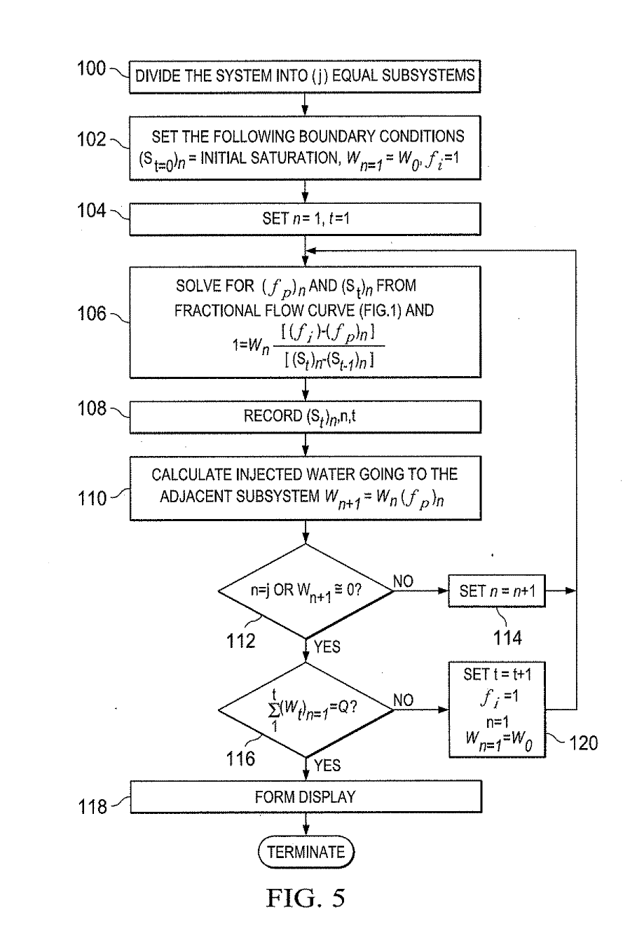

At the outset, an explanation of the physical aspects and relationships of two phase fluid flow is provided. A model known as the Buckley Leverett model was derived based on the presence of certain physical conditions for the model. The fluid displacement is one dimensional, and conditions are at equilibrium. Fluid pressure is maintained, and the fluids are immiscible. Gravity and capillary pressures are deemed negligible, and the fluids are incompressible. FIG. 1 is a graphical display of a synthetic fractional flow profiles as a function of saturation, which is typically generated from laboratory experiments on a core sample of formation rock. This input data is used to give an ideal output profile of the prior art Buckley Leverett model method.

For a displacement process where water displaces oil, the fractional flow of water at any point in a core plug or reservoir is defined as:

$${f}_{w} = \frac{{q}_{w}}{{q}_{w} + {q}_{o}} where \\ {q}_{w} = \frac{{kk}_{rw} A \frac{Δ {p}_{w}}{Δ L}}{{μ}_{w}} and {q}_{o} = \frac{{kk}_{ro} A \frac{Δ {p}_{o}}{Δ L}}{{μ}_{o}} \\ ⇒ {f}_{w} = \frac{\frac{{kk}_{rw} A \frac{Δ {p}_{w}}{Δ L}}{{μ}_{w}}}{\frac{{kk}_{rw} A \frac{Δ {p}_{w}}{Δ L}}{{μ}_{w}} + \frac{{kk}_{ro} A \frac{Δ {p}_{o}}{Δ L}}{{μ}_{o}}} \qquad Equation ( 1 )$$

Assuming that the pressure gradients in the water and oil are similar and neglecting capillary pressure effects, the above equation becomes:

$$⇒ {f}_{w} = \frac{1}{1 + \frac{{μ}_{w}}{{μ}_{o}} \frac{{k}_{ro}}{{k}_{rw}}} \qquad Equation ( 2 )$$

With the application of a mass balance of water around a control volume of length for a certain period of time, the mass balance can be written as:

[(q_{w}ρ_{w})ₓ− [symbol] (q [symbol] _{w}ρ_{w})_{x+Δx}]Δt=AΔxφ[(S_{w}ρ_{w})_{t+Δt}−(S_{w}ρ_{w})ₜ] Equation (3)

Assuming that the water is incompressible, the above equations becomes:

$$[ {( {q}_{w} )}_{K} - {[ {( ( q ] )}_{w} )}_{K + Δ t} ] Δ t = A Δ x φ [ {( {S}_{w} )}_{t + Δ t} - {( {S}_{w} )}_{t} ] \text{?} \frac{Δ z}{Δ t} = \frac{1}{A φ} \frac{[ {( {q}_{w} )}_{x} - \text{?} ]}{[ \text{?} - \text{?} ]} \\ \text{?} \text{indicates text missing or illegible when filed} \qquad Equation ( 4 )$$

If Δx→0 and Δt→0 and substituting the flow rates in Equation (3) by the fractional flow term from Equation (1), the conventional known Buckley Leverett equation model is:

$$\frac{d x}{d t} = \frac{q}{A φ} \frac{d {f}_{w}}{d {S}_{w}} \qquad Equation ( 5 )$$

The integration of Equation (4) has the following form which describes the flood front advancement:

$$X = \frac{q t}{A φ} \frac{d {f}_{w}}{d {S}_{w}} \qquad Equation ( 6 )$$

To plot the flood front,

$$\frac{d {f}_{w}}{d {S}_{w}} or {f}_{w}^{′}$$

can be calculated from the fractional flow curve that is generated from the relative permeability using Equation (2) and then back substituting the values in Equation (6). FIG. 1 is an example plot of a fractional fluid flow profile f_{w} and its derivative f′_{w} as a function of water saturation S_{w}.

However, in the original Buckley Leverett model, as is evident from FIG. 2, the computed water saturation profile has three saturations values at any distance, i.e. S_{w1}, S_{w2} and S_{wc}. The Buckley Leverett model was modified and a shock front saturation introduced to add a realistic meaning to the original model plotted in FIG. 2. The connate water saturation line prior to the shock front and most of the saturation curve derived from the Buckley Leverett equation were eliminated and replaced by the shock front (FIG. 3). The mathematical solution for the front was derived later by others utilizing the concept of average water saturation.

As is evident from FIG. 2, the Buckley Leverett model provides multiple saturations at each point along the distance plot, which is physically impossible. It has been proposed by others that this problem with the Buckley Leverett model resides in the relative permeability functions.

The Buckley Leverett model is a representation of a mass balance for a system at equilibrium conditions. The model indicates in the accumulation of the displacing fluid for a certain time interval, the change in saturation is equal to the difference of the displacing fluid volume entering the system to the one exiting the system, as shown in Equation (4). This indicates that f_{w}′ is expressed as:

$$\frac{[ {( {q}_{w} )}_{x} - {[ {( ( q ) ]}_{w} )}_{x + Δ x} ]}{[ {( {S}_{w} )}_{t + Δ t} - {( {S}_{w} )}_{t} ]} = \frac{[ {( {f}_{w} )}_{x} - {[ {( ( f ) ]}_{w} )}_{x + Δ x} ]}{[ {( {S}_{w} )}_{t + Δ t} - {( {S}_{w} )}_{t} ]} \\ where {q}_{w} in dimensionless form \\ ⇒ \frac{[ {( {f}_{w} )}_{x} - {[ {( {( f )}_{w} )}_{x + Δ x} ]}_{t + Δ t}}{[ {( {S}_{w} )}_{t + Δ t} - {( {S}_{w} )}_{t} ]} = \frac{d {f}_{w}}{d {S}_{w}} \\ when Δ x \to 0 and Δ t \to 0 \qquad Equation ( 7 )$$

With the present invention, it has been determined that the errors in the flood front advancement calculations discussed above are because the models were not implemented correctly. The f_{w}′ used in the calculation of the front (Equation 7) is not the same physical object as f_{w}′ which is obtained from the Buckley Leverett model. The f_{w}′ of FIG. 7 is generated from data measured during relative permeability experiments in laboratory testing, which do not consider the inlet injected volume in the generation of the fractional flow curve (FIG. 1). In mathematical terms, the f_{w}′ of FIG. 7 should be expressed as:

$$\frac{[ {( {q}_{w} )}_{t + Δ t} - {[ {( ( q ) ]}_{w} )}_{t} ]}{[ {( {S}_{w} )}_{t + Δ t} - {( {S}_{w} )}_{t} ]} = \frac{[ {( {f}_{w} )}_{t + Δ t} - {[ {( ( f ) ]}_{w} )}_{t} ]}{[ {( {S}_{w} )}_{t + Δ t} - {( {S}_{w} )}_{t} ]} \\ where {q}_{w} is in dimenstionless form \\ ⇒ \frac{{[ {( {f}_{w} )}_{t + Δ t} - {[ {( ( f ) ]}_{w} )}_{t} ]}_{x + Δ x}}{[ {( {S}_{w} )}_{t + Δ t} - {( {S}_{w} )}_{t} ]} = \frac{d {f}_{w}}{d {S}_{w}} \\ when Δ x \to 0 and Δ t \to 0 \qquad Equation ( 8 )$$

Thus, it can be seen that the f_{w}′ in Equation (8) is not the same f_{w}′ as that in Equation (7). The first one accounts for the change in rate at the outlet of a system while the second one accounts for the difference of the rate between the inlet and the outlet points of a system. The f_{w}′ in Equation (7) also violates the equilibrium assumptions of Buckley Leverett because the rates at the inlet and the outlet should not change with time. The physical meaning of the solution when using the incorrect f_{w}′ is that the accumulation of the displacing fluid for a certain time interval inside a system is equal to change of the produced volumes of that fluid, which cannot physically occur.

It can thus be demonstrated that the values of f_{w}′ cannot be taken directly from the fractional flow curves derived from the relative permeability experiment and applied to Buckley Leverett model, due to inconsistency in the physical meaning. The present invention provides a model with a new and improved approach for modeling a flood front saturation profile in earthen rock where f_{w}′ can be used directly in the model without any inconsistencies.

Equation (6) can be expressed in the correct form according to the present invention as:

$$1 = \frac{q t}{X A φ} \frac{[ {( {f}_{w} )}_{x} - {( {f}_{w} )}_{x + Δ x} ]}{[ {( {S}_{w} )}_{t + Δ t} - {( {S}_{w} )}_{t} ]} \qquad Equation ( 9 )$$

For a water flooding system that has an injection point and a production point, and t₀=0, the Equation (9) can be re-written as:

$$1 = \frac{q Δ t}{X A φ} \frac{[ {( {f}_{w} )}_{i} - {[ {( ( f ) ]}_{w} )}_{p} ]}{[ {( {S}_{w} )}_{Δ t} - ( {S}_{w i} ) ]} \qquad Equation ( 10 )$$

Since both the numerator and denominator represent the same system, the factor should represent the dimensionless pore volume of water injected into the system:

$$\frac{q Δ t}{X A φ} = P {V}_{i} \qquad Equation ( 11 )$$

By substituting Equation (11) into Equation (10), the equation becomes:

$$1 + P {V}_{i} \frac{⌊ {( {f}_{w} )}_{i} - {[ {( ( f ) ]}_{w} )}_{p} ⌋}{[ {( {S}_{w} )}_{Δ t} - ( {S}_{w i} ) ]} \qquad Equation ( 12 )$$

To track down the forward propagation of the front as it is being injected system of known fractional flow curve, the system should be divided into subsystems of a fixed Δx. The fractional flow curve should be known and the fractional flow curve should be plotted against the average water saturation.

The unknown parameters in this equation for each Δx are (f_{w})ₚ and [symbol] (S [symbol] _{w})_{Δt}. The injected water ratio (f_{w})ᵢ and the initial water saturation prior to injection [symbol] (S [symbol] _{wi}) are fixed parameters that can be measured easily. The pore volume injected [symbol] (PV [symbol] ᵢ) is a variable that is a function of time and can be obtained using Equation (11). This will leave two unknowns, (f_{w})ₚ and [symbol] (S [symbol] _{w})_{Δt}. The values of the unknowns can be found by utilizing the fraction flow curve to find the appropriate values that satisfies the equation.

The same technique can be used for the backward tracking of the flood front. In this case, (f_{w})ₚ and [symbol] (S [symbol] _{w})_{Δt} are fixed known parameters, while (f_{w})ᵢ and [symbol] (S [symbol] _{wi}) are the unknowns and should be solved for using the fractional flow curves. The present invention uses the foregoing analysis in forming models of fluid flow in computerized analysis of subterranean reservoirs and rock formations, based on porous media segments or samples.

As illustrated in FIG. 4, a data processing system D according to the present invention includes a computer 40 having a processor 42 and memory 44 coupled to the processor 42 to store operating instructions, control information and database records therein. The computer 40 may, if desired, be a portable digital processor, such as a personal computer in the form of a laptop computer, notebook computer or other suitable programmed or programmable digital data processing apparatus, such as a desktop computer. It should also be understood that the computer 40 may be a multicore processor with nodes such as those from Intel Corporation or Advanced Micro Devices (AMD), or a mainframe computer of any conventional type of suitable processing capacity such as those available from International Business Machines (IBM) of Armonk, N.Y. or other source.

The computer 40 has a user interface 46 and an output display 48 for displaying output data or records of processing of well logging data measurements performed according to the present invention to obtain a measure of transmissibility of fluid in subsurface formations. The output display 48 includes components such as a printer and an output display screen capable of providing printed output information or visible displays in the form of graphs, data sheets, graphical images, data plots and the like as output records or images.

The user interface 46 of computer 40 also includes a suitable user input device or input/output control unit 50 to provide a user access to control or access information and database records and operate the computer 40. Data processing system D further includes a database 52 stored in computer memory, which may be internal memory 44, or an external, networked, or non-networked memory as indicated at 54 in an associated database server 56.

The data processing system D includes program code 60 stored in memory 44 of the computer 40. The program code 60, according to the present invention is in the form of computer operable instructions causing the data processor 42 to form obtain a measure of transmissibility of fluid in subsurface formations, as will be set forth.

It should be noted that program code 60 may be in the form of microcode, programs, routines, or symbolic computer operable languages that provide a specific set of ordered operations that control the functioning of the data processing system D and direct its operation. The instructions of program code 60 may be may be stored in memory 44 of the computer 40, or on computer diskette, magnetic tape, conventional hard disk drive, electronic read-only memory, optical storage device, or other appropriate data storage device having a computer usable medium stored thereon. Program code 60 may also be contained on a data storage device such as server 64 as a computer readable medium, as shown.

A flow chart F of FIG. 5 herein illustrates the structure of the logic of the present invention as embodied in computer program software. Those skilled in the art appreciate that the flow charts illustrate the structures of computer program code elements that function according to the present invention. The invention is practiced in its essential embodiment by computer components that use the program code instructions in a form that instructs the digital data processing system D to perform a sequence of processing steps corresponding to those shown in the flow chart F.

With reference to FIG. 5, the flow chart F is a high-level logic flowchart illustrates a method according to the present invention of forming a measure of transmissibility of fluid in subsurface formations. The method of the present invention performed in the computer 40 can be implemented utilizing the computer program steps of FIG. 4 stored in memory 44 and executable by system processor 42 of computer 40. The input data to processing system D are laboratory or other data including the initial water saturation values, system length, porosity, injected volume and ratio data, and data regarding fractional flow curves (or relative permeability of formation rock samples to oil and to water).

As shown in the flow chart F of FIG. 5, a preferred sequence of steps of a computer implemented method or process for obtaining a measure of saturation of porous media segments of earth formation rock to an injected volume of fluid is illustrated schematically.

For a porous media segment or system that follows Buckley Leverett conditions and has a fluid, such as water, that is being injected to displace another fluid, such as oil, the flow can be described by the following relationship:

$$1 = {[ {( ( W ) ]}_{t} )}_{n} \frac{[ ( {f}_{i} ) - {[ {( ( f ) ]}_{p} )}_{n} ]}{[ {( {S}_{t} )}_{n} - {( {S}_{t - 1} )}_{n} ]} \qquad Equation ( 13 )$$

### Where:

n: the subsystem or length increment number among increments in the segment, which is equal to 1 at the injecting point
t: the time step of injection, which is equal to 0 prior to injection
Wₙ: Volume of fluid injected in the subsystem n at time step t
fᵢ: Fractional flow of the injected fluid [symbol]
(f [symbol] ₚ)ₙ: Fractional flow of the produced fluid
(Sₜ)ₙ: Saturation of injected fluid at the increment or subsystem n
(Sₜ₋₁)ₙ: Saturation of the injected fluid at the increment or subsystem n in the previous time step.
Q: Total volume of fluid injected.

The water saturation S_{w} can be determined as a function of time and one-dimension space in the segment by the applying the method described below which is illustrated schematically in the process sequence of FIG. 5. During step 100, the length of the porous media segment or sample is be divided in the computer data into (j) smaller subsystems of equal length, and the total volume injected is allocated in the computer data into smaller volumes. The discretization of the volumes injected should represent the volume injected during a time step such that

$$Q = {\sum }_{1}^{t} {( {W}_{t} )}_{n = 1} \qquad Equation ( 14 )$$

The injected water ratio (fᵢ), the initial water saturation prior to injection [symbol] (S [symbol] ₜ₊₀) and the injected volume [symbol] (W [symbol] ₜ)ₙ₌₁ are known parameters that can be experimentally measured. As indicated at step 102, these initial parameters are provided as input data for use in further processing.

During step 104, initial counts are set for processing to be performed for the first length increment located at injection point for the first time step, where n=1, t=1

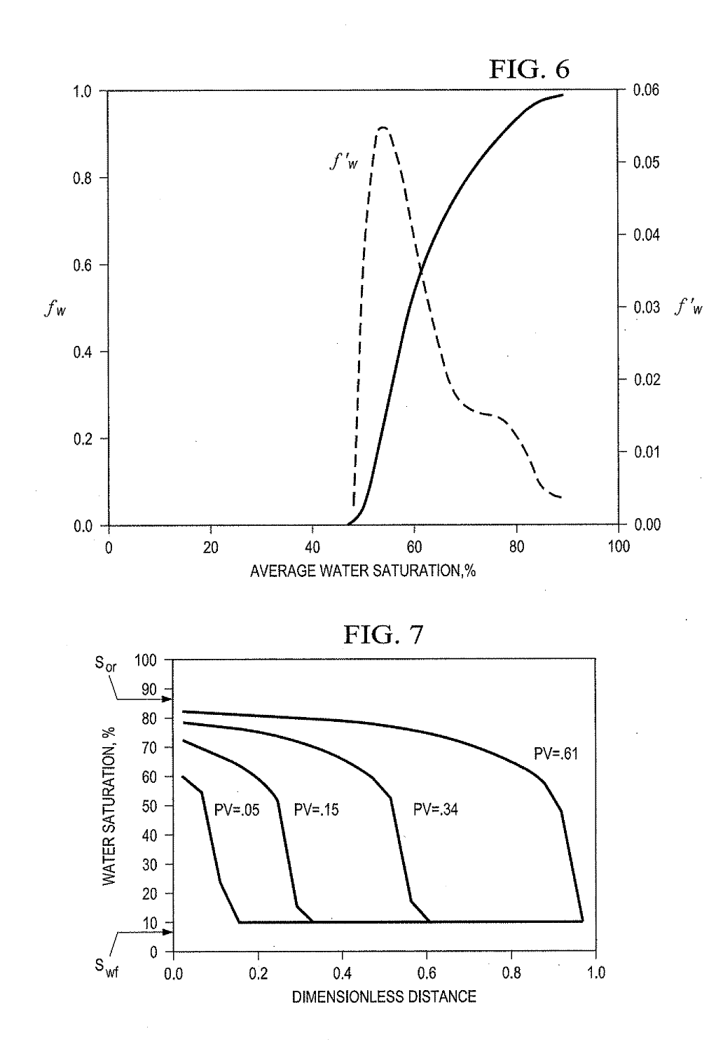

During step 106, the fractional flow of the produced fluid (fₚ) and the saturation of the injected fluid [symbol] (S [symbol] ₜ)ₙ at the length increment n should be found by utilizing the pre-determined fraction flow curve (FIG. 6) to find the appropriate values of (fₚ) and [symbol] (S [symbol] ₜ)ₙ that satisfy Equation 13. This can be done in several ways, such as by using a conventional computer numerical solution method such as the Newton's method or by other computerized optimization or iterative trial and error method. During step 108, the determined values for fractional flow and saturation of the injected fluid for the present length increment n are stored in memory.

During step 110, the values of (fₚ) and [symbol] (S [symbol] ₜ)ₙ at the current length increment n are used for material balance computations to find what remaining volume that is available to be injected in the adjacent subsystem by applying the following equation: Wₙ₊₁=Wₙ(fₚ)ₙ

During step 112, a decision is made based on whether volume injected in the adjacent time step (Wₙ₊₁) is not equal to zero. If such is the case, this means that there is still some fluid to flow into the next adjacent length increment n+1. In this event, during step 114, the length n is incremented and the values of (fₚ) and [symbol] (S [symbol] ₜ)ₙ are to be found for the adjacent length increment and processing continues by returning to step 106.

If the subsystem number n is equal to j, it means that the saturation was measured for all the subsystems at the specified time step. If volume injected in the adjacent time step (Wₙ₊₁) is indicated equal to zero during step 112, then the total injected volume injected at the specified time step t has entered into the previous length increments, and no more mobile fluid is left to enter the next adjacent length increment. The flood front saturation profile can be obtained for the whole sample at that time step t by plotting [symbol] (S [symbol] ₜ)ₙ of the length increments 1 through n as a function of distance.

During step 116, a decision is made based on whether the cumulative volume injected in the length increment is equal to the total volume injected in the segment. If this is so indicated, further processing should terminate and the saturation profiles are plotted as indicated in step 118. An out put display thus plotted represents the flood saturation as a function of time and space in one-dimension. If during step 116 the cumulative fluid injected does not yet equal the total volume injected, the time interval counter t is increased during step 120.

For determining the saturation profile at the next time step, [symbol] (W [symbol] ₜ) is equal to the injected volume during this time step, and the [symbol] (S [symbol] ₜ₋₁)ₙ is equal to the [symbol] (S [symbol] ₜ)ₙ from the previous time step.

The processing is performed for the next time step using the volume of water injected during that time step and processing returns to step 106 for continued data value determinations.

FIG. 6 illustrates an example display of the input used for forward tracking of a flood front according to the present invention. It is typically generated from laboratory experiments on a core sample of formation rock. In this example, the data was generated from steady state core-flood experiments. The core length was chosen to be Δx and has a dimensionless length. The processing was carried out to see the behaviour of the flood front for a segment that was assumed to have similar petrophysical properties to the entire core. The processing was carried out for different amounts of pore volumes and the front advancement was tracked down until the saturation reached the initial connate water saturation of the sample. Unlike a conventional Buckley Leverett front model, the solution for each front plotted in FIG. 7 is unique and no multiple values were generated. It is also clear the shock front phenomenon appears in the front without any need to enforce it in the plot to match reality.

The flood saturation profile of FIG. 7 indicates a pore volume or PV ratio determined with reference to largest core volume. The PV ratio is based on the pore volume of the segment that has a dimensionless distance of 1 unit.

The saturation profiles plotted in FIG. 7 are displayed as actual values for each successive length increment but can also be smoothed compared to the actual calculated increment values. The original Buckley Leverett model apparently assumed related fractional flow to be the average water saturation rather than the actual saturation at any point.

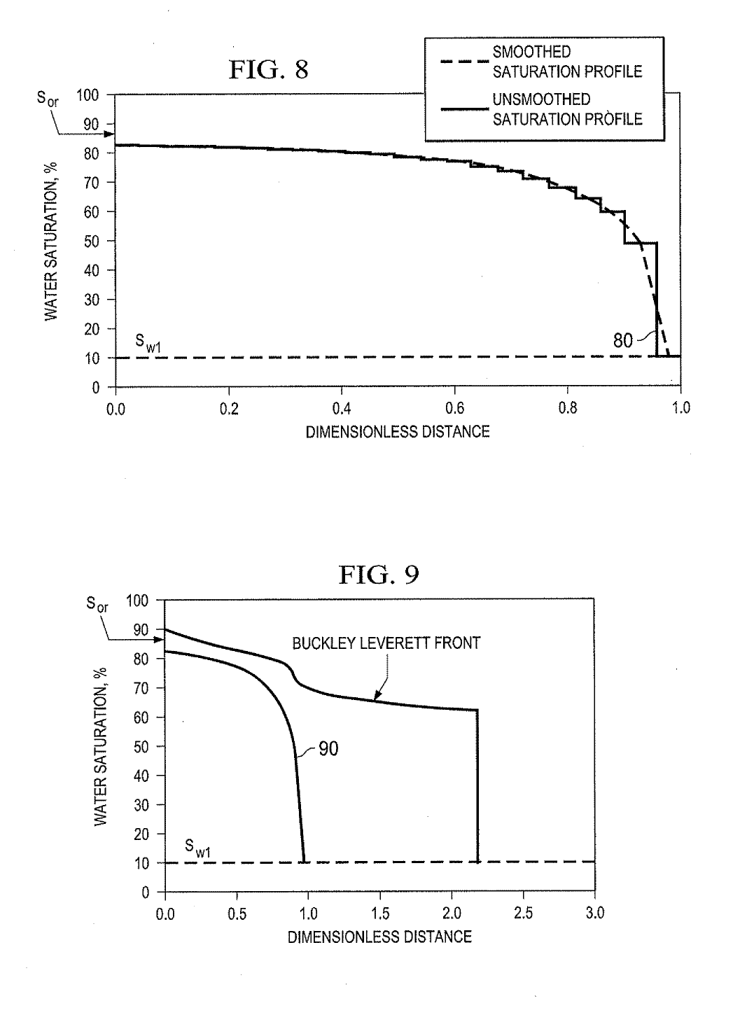

The present invention by contrast forms a model of water saturation based on actual saturation of a very small Δx length increment of the sample. In the plot of FIG. 7, the Δx increment was arbitrarily chosen to be the length of the core and the values were used to honor the saturation only at the middle of step of Δx to smooth the curves. The shape of the original curve compared to the smoothed one is shown on FIG. 8. It should be noted that the marked differences between determined model saturation profile values at each successive length in the data plot can be avoided by selection of a very small Δx length increment.

Another comparison was conduced between saturation profile proposed by Buckley Leverett with one according to the present invention is shown in FIG. 9. The same amount of volume injected was used in both schemes of front calculation (dimensionless volume=0.61). The dimensionless distance here refers to the core length.

A simple visual comparison between the two curves reveals certain things. The Buckley Leverett front model of FIG. 9 does not show the same volume of water injected compared to the original volume used in the calculation of the front movement. The area under the front curve and above the initial saturation line should represent the dimensionless volume of water injected. The area under the Buckley Leverett front model of FIG. 9 shows that the volume injected is 1.59, which is not equal to the injected volume of 0.61, which was used as an input to the model. This indicates clearly that Buckley Leverett frontal model violates material balance rules. The front plotted from the method of the present invention shows an injected volume of 0.61, which is similar to one used in the front movement calculations.

The Buckley Leverett front model of FIG. 9 shows an inflection point at a distance equal to 1. This is because the front is very sensitive to changes in derivative of the fractional flow curve while the front model according to the present invention is not.

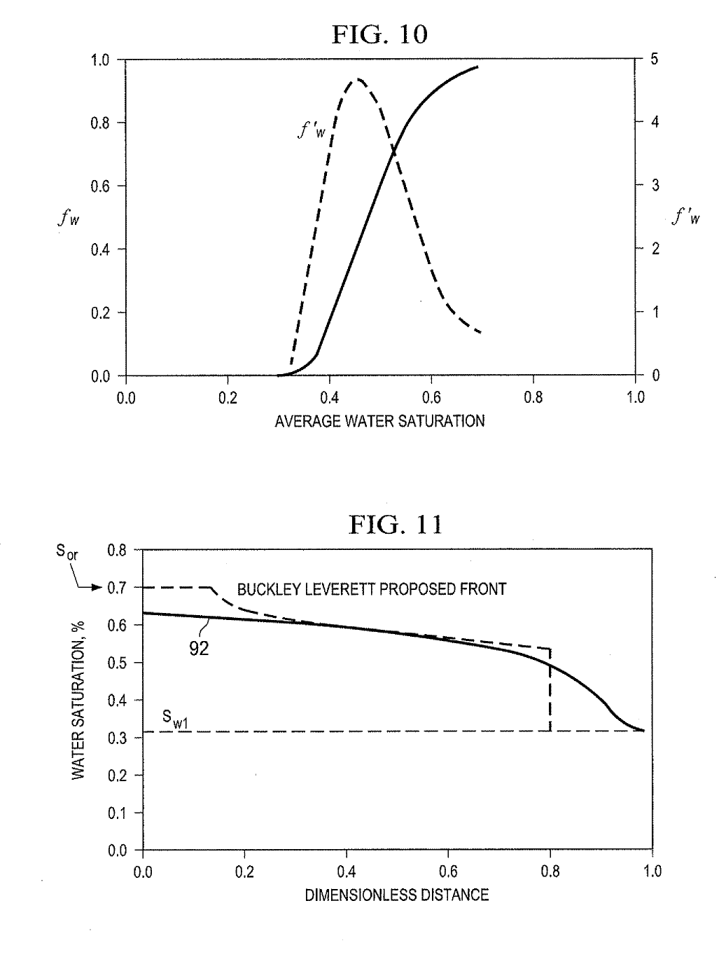

The conventional Buckley Leverett front model and the front model formed according to the present invention were also examined for a synthetic data set that best suited the Buckley Leverett front model. The suitability of the data in this context refers to a conventional monotonic shape of the derivate, since that may reduce many errors in the conventional Buckley Leverett front model. FIG. 10 shows the synthetic fractional flow data and saturation front if injected in a core. A comparison between the models is shown in FIG. 11 where the present invention has a well developed smoother realistic shock front (right side of the curves) while Buckley Leverett model show a sharp shock front represented by a straight line, which is an artefact introduced by Weldge modification to the Buckley Leverett model. This artefact is well known in the prior art but was not modelled smoothly except for the present invention.

Another less important difference between the models output of FIG. 11 is on the left side of the curves. The present invention shows a more realistic estimate of Sₒᵣ when compared to the Buckley Leverett model. This is because the Buckley Leverett model sets the first few points directly to Sₒᵣ while the present invention assigns high oil saturation values at a slower and gradual rate. The new invention better matches reality because reaching the Sₒᵣ value is not an easy process as could be indicated from Buckley Leverett model.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. A computer implemented method of obtaining a measure of saturation of a porous media segment of earth formation rock to an injected volume of fluid, comprising the steps of:
partitioning a length of a system sample of the porous media segment into a number of sample length increments;
forming a measure of the volume of injected fluid injected into a sample length increment during a selected time increment;
forming a measure of fractional flow of fluid produced in the sample length increment by the injected fluid during the selected time increment;
forming a measure of the fluid saturation for the injected fluid in the sample length increment during the selected time increment;
forming a record of the measure of the of the fluid saturation for the injected fluid in the sample length increment during the selected time increment;
forming a measure of the remaining volume of the fluid not saturated into the sample length increment during the selected time increment.

2. The computer implemented method of claim 1, further including the steps of:
determining whether the formed measure of remaining volume of fluid indicates presence of a remaining volume of fluid for injection into an adjacent length sample increment of the porous media segment;
if so, repeating the steps of forming a measure of the volume of injected fluid injected, forming a measure of fractional flow of fluid, forming a measure of the fluid saturation, forming a record of the measure of the fluid saturation, and forming a measure of the remaining volume of the fluid not saturated into the adjacent sample length increment during the selected time increment;
if not, forming a measure of the saturation profile for the length sample increment by the injected fluid during the selected time increment.

3. The computer implemented method of claim 2, further including the step of incrementing the selected time increment to a new selected time increment subsequent to the step of forming a measure of the saturation profile for the length sample increment by the injected fluid during the selected time increment.

4. The computer implemented method of claim 3, further including the steps of:
forming a measure of the volume of injected fluid injected into a length sample increment during the new time increment;
forming a measure of fractional flow of fluid produced in the length sample increment by the injected fluid during the new time increment;
forming a measure of the fluid saturation for the injected fluid in the length sample increment during the new time increment;
forming a record of the measure of the of the fluid saturation for the injected fluid in the length sample increment during the new time increment;
forming a measure of the remaining volume of the fluid not saturated into the length sample increment during the new time increment.

5. The method of claim 1, wherein the injected fluid comprises water.

6. The method of claim 1, wherein the porous media segment comprises a core sample.

7. The method of claim 1, wherein the porous media segment comprises a subterranean formation segment.

8. The method of claim 1, further including the step of:
forming an output display of the determined measure of fluid saturation for the injected fluid.

9. A data processing system for forming a measure of saturation of a porous media segment of earth formation rock to an injected volume of fluid, the data processing system comprising:
a data storage memory;
a processor for performing the steps of:
partitioning a length of a system sample of the porous media segment into a number of sample length increments;
forming a measure of the volume of injected fluid injected into a sample length increment during a selected time increment;
forming a measure of fractional flow of fluid produced in the sample length increment by the injected fluid during the selected time increment;
forming a measure of the fluid saturation for the injected fluid in the sample length increment during the selected time increment;
forming a record in the data storage memory of the measure of the of the fluid saturation for the injected fluid in the sample length increment during the selected time increment;
forming a measure of the remaining volume of the fluid not saturated into the sample length increment during the selected time increment.

10. The data processing system of claim 9, wherein the processor further performs the steps of:
determining whether the formed measure of remaining volume of fluid indicates presence of a remaining volume of fluid for injection into an adjacent length sample increment of the porous media segment;
if so, repeating the steps of forming a measure of the volume of injected fluid injected, forming a measure of fractional flow of fluid, forming a measure of the fluid saturation, forming a record of the measure of the fluid saturation, and forming a measure of the remaining volume of the fluid not saturated into the adjacent sample length increment during the selected time increment;
if not, forming a measure of the saturation profile for the length sample increment by the injected fluid during the selected time increment.

11. The data processing system of claim 10, wherein the processor further performs the steps of:
incrementing the selected time increment to a new selected time increment subsequent to the step of forming a measure of the saturation profile for the length sample increment by the injected fluid during the selected time increment.

12. The data processing system of claim 11, wherein the processor further performs the steps of:
forming a measure of the volume of injected fluid injected into a length sample increment during the new time increment;
forming a measure of fractional flow of fluid produced in the length sample increment by the injected fluid during the new time increment;
forming a measure of the fluid saturation for the injected fluid in the length sample increment during the new time increment;
forming a record of the measure of the of the fluid saturation for the injected fluid in the length sample increment during the new time increment;
forming a measure of the remaining volume of the fluid not saturated into the length sample increment during the new time increment.

13. The data processing system of claim 11, further including:
an output display forming an output record of the determined measure of fluid saturation for the injected fluid.

14. The data processing system of claim 9, wherein the injected fluid comprises water.

15. The data processing system of claim 9, wherein the porous media segment comprises a core sample.

16. The data processing system of claim 9, wherein the porous media segment comprises a subterranean formation segment.

17. A data storage device having stored in a computer readable medium computer operable instructions for causing a data processing system to form a measure of saturation of a porous media segment of earth formation rock to an injected volume of fluid, the instructions stored in the data storage device causing the data processing system to perform the following steps:
partitioning a length of a system sample of the porous media segment into a number of sample length increments;
forming a measure of the volume of injected fluid injected into a sample length increment during a selected time increment;
forming a measure of fractional flow of fluid produced in the sample length increment by the injected fluid during the selected time increment;
forming a measure of the fluid saturation for the injected fluid in the sample length increment during the selected time increment;
forming a record for storage in the data processing system of the measure of the of the fluid saturation for the injected fluid in the sample length increment during the selected time increment;
forming a measure of the remaining volume of the fluid not saturated into the sample length increment during the selected time increment.

18. The data storage device of claim 17, further including the stored instructions containing instructions causing the data processing system to perform the steps of:
determining whether the formed measure of remaining volume of fluid indicates presence of a remaining volume of fluid for injection into an adjacent length sample increment of the porous media segment;
if so, repeating the steps of forming a measure of the volume of injected fluid injected, forming a measure of fractional flow of fluid, forming a measure of the fluid saturation, forming a record of the measure of the of the fluid saturation, and forming a measure of the remaining volume of the fluid not saturated into the adjacent sample length increment during the selected time increment;
if not, forming a measure of the saturation profile for the length sample increment by the injected fluid during the selected time increment.

19. The data storage device of claim 18, further including the stored instructions containing instructions causing the data processing system to perform the steps of:
incrementing the selected time increment to a new selected time increment subsequent to the step of forming a measure of the saturation profile for the length sample increment by the injected fluid during the selected time increment.

20. The data storage device of claim 19, further including the stored instructions containing instructions causing the data processing system to perform the steps of:
forming a measure of the volume of injected fluid injected into a length sample increment during the new time increment;
forming a measure of fractional flow of fluid produced in the length sample increment by the injected fluid during the new time increment;
forming a measure of the fluid saturation for the injected fluid in the length sample increment during the new time increment;
forming a record of the measure of the of the fluid saturation for the injected fluid in the length sample increment during the new time increment;
forming a measure of the remaining volume of the fluid not saturated into the length sample increment during the new time increment.

21. The data storage device of claim 17, the injected fluid comprises water.

22. The data storage device of claim 17, wherein the porous media segment comprises a core sample.

23. The data storage device of claim 17, wherein the porous media segment comprises a subterranean formation segment.

24. The data storage device of claim 17, further including the stored instructions containing instructions causing an out put display of the data processing system to perform the steps of:
forming an output record of the determined measure of fluid saturation for the injected fluid.
